(19) United States
(12) Patent Application Publication
(10) Pub. No.: US 2011/0010196 A1
(43) Pub. Date: Jan. 13, 2011

(54) PHARMACEUTICAL INVENTORY TRACKING SYSTEM AND METHOD

(76) Inventors: Christopher Nee, Fullerton, CA (US); Joseph Perez, Yorba Linda, CA (US)

Correspondence Address: STETINA BRUNDA GARRED & BRUCKER, 75 ENTERPRISE, SUITE 250, ALISO VIEJO, CA, 92656, US

(21) Appl. No.: 12/540,674

(22) Filed: Aug. 13, 2009

Related U.S. Application Data
(60) Provisional application No. 61/223,979, filed on Jul. 8, 2009.

(51) Int. Cl. G06Q 50/00; G06Q 10/00

(52) U.S. Cl. 705/3; 705/2

(57) ABSTRACT

In accordance with the present invention, there is provided a pharmaceutical inventory review and tracking system and method particularly suited to provide virtual inventory management and tracking in a manner effectively monitoring and eliminating the waste currently associated with many prescription writing and filling protocols. The present invention provides management processes that review clinical appropriateness of a prescribed medication and can identify waste, and is designed to be a re-usable process adapted to minimize such waste and insure medication inventory is conserved.

### CROSS-REFERENCE TO RELATED APPLICATIONS

The present application claims priority to, and incorporates the teachings of U.S. Provisional Patent Application Ser. No. 61/223,979 entitled PHARMACEUTICAL INVENTORY TRACKING SYSTEM & METHOD, filed Jul. 8, 2009.

### STATEMENT RE: FEDERALLY SPONSORED RESEARCH/DEVELOPMENT

Not Applicable

### BACKGROUND OF THE INVENTION

1. Technical Field of the Invention

The present invention relates generally to professional data management systems and, more particularly, to a pharmaceutical inventory tracking system and method particularly suited to provide virtual inventory management and tracking in a manner effectively monitoring and eliminating waste, as well as insuring quality and oversight in dispensing medications.

2. Description of the Related Art

Despite the widespread use of computers and electronic data transmission in virtually every aspect of society, prescription writing by a physician is still, in large measure, a manual process. More particularly, the attending physician will often manually prepare a prescription request wherein information regarding the drug therapy is written on a prescription form, with the patient then submitting such prescription form to a pharmacist who subsequently fills the prescription (i.e., prepares the medication). In order to at least minimize the amount of time required before a patient can receive the prescribed medication physicians or their assistants will sometimes place a telephone call to the pharmacy and submit the prescription request telephonically. The prescription request is then filled by the pharmacist and the medication subsequently retrieved by the patient.

In addition to the shortcomings of many doctors offices with regard to the use of modern information technology and computers in relation to the generation of prescriptions, many pharmacies suffer from similar shortcomings. More particularly, many pharmacies still rely upon somewhat rudimentary inventory systems, such as Microsoft Office® based systems wherein inventory is tracked by Excel® and information regarding medications is stored in Word® documents.

In recent years, attempts have been made in the medical community to impart some level of computerization to the prescription writing and filling process to increase the efficiency thereof. These efforts, to date, have largely been confined to transactions between pharmacies and doctors offices being conducted through the use of simple email, such as Microsoft Outlook®. Though the transmission of a prescription email from a doctor's office to a pharmacy provides a simple form of electronic communication between these entities, this particular form of communication is unsuitable for operatively interfacing with the above-described inventory tracking and management systems implemented at many pharmacies, nor are such systems capable of accepting an operative interface from an external electronic data source. As a result, the receipt by the pharmacy of a prescription either in a written prescription format, a telephonic request, or an email request, still often requires that separate inquiries and/or inputs be made into the existing inventory tracking system. The inefficiencies created by the disconnect between the prescription request and prescription processing and inventory tracking protocols at the pharmacy are heightened by the typical need for the pharmacy to access yet additional databases regarding the particulars of the patient's insurance coverage and the applicability thereof to the prescription request.

In 2005, Congress passed the Medicare Modernization Act (MMA) to reform how Medicare recipients access healthcare. As part of the MMA, a mandate was issued to manage healthcare expenses against fraud, waste, and abuse. Based on current market surveillance, numerous entities have focused on the fraud and abuse sides of the MMA. This is because many of the fiscal intermediaries for Medicare have access to claims data which are retrospective in nature. Since management is often based on past claims history, many entities can only focus on matching what was paid versus what was used based on audits to identify fraud and abuse. As such, these entities often deem it impractical to manage the “waste” which requires such managing entities to know what drugs or medications are being used or not in a real-time basis, and much less whether the drugs/medications are appropriate, covered by a specific healthcare plan or redundant with medications previously supplied to the patient, a task not easily accomplished based on the shortcomings highlighted above. Additionally, often contributing to waste is the established pharmacy practice that if a medication leaves the pharmacy, such medication cannot be returned. This practice may be particularly problematic and wasteful when costly, specialty drugs are involved, such as those used in the oncology field for cancer treatment. Thus, particularly in specialized treatment fields such as oncology, the aforementioned issues make managing waste an exceedingly difficult process.

The present invention, as will be described in more detail below, is particularly suited to address the need in the art for an efficient system to address the issue of waste as it relates to the prescription generation and filling process.

### BRIEF SUMMARY OF THE INVENTION

As indicated above, the present invention is directed to a pharmaceutical inventory tracking system and method particularly suited to provide virtual inventory management and tracking in a manner effectively monitoring and eliminating the waste currently associated with many prescription writing and filling protocols. With particular regard to the oncology field, the management of waste in the oncology medication process has been studied and analyzed by Applicant for many years. The present invention provides a management process that can identify waste, and is designed to be a re-usable process adapted to minimize such waste. In this regard, the present invention provides a virtual inventory management process for each medication managed thereby. By knowing if a medication is appropriate, and if so whether the same is used or not, the unused medication can be re-assigned to another patient needing the same medication within an oncologist practice setting.

The virtual inventory processes implemented in accordance with the present invention allows for the management of potential waste in a number of ways. More particularly, system of the present invention recognizes, among other things, whether certain drugs or medications are appropriate in certain clinical applications, are attendant to fee for service (FFS), can only be used once as being designated as a single use medication, or whether it can be used multiple times within a set parameter as being designated as a multi-use drug. The pharmacy virtual inventory management processes implemented by the system of the present invention can also be used to perform inventory management for both types of designations and, as such, allows for the optimization of these drugs in the most efficient and least wasteful way. Though being particularly useful for the oncology field or others areas of specialized treatment, those of ordinary skill in the art will recognize that the pharmacy virtual inventory process provided under the present invention may be applied to any practice setting or medication.

The present invention is best understood by reference to the following detailed description when read in conjunction with the accompanying drawings.

### BRIEF DESCRIPTION OF THE DRAWINGS

These, as well as other features of the present invention, will become more apparent upon reference to the drawings wherein:

FIGS. 1A through 1H are six pages of a comprehensive flow chart detailing the data input parameters and processing resources attendant to the implementation of the pharmaceutical inventory tracking system and method of the present invention.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

The present invention is directed to devising and developing an Integrated Single Specialty Provider (ISSP) Service platform that integrates the management of the professional services related to the delivery of healthcare with medication management, and in particular to enhance the efficiencies and cost-effectiveness related to the medication management platform.

In this regard, the inventors saw a need to build and integrate a complete platform to manage the ISSP services as they relate to pharmacy/medication management. To that end, the following were determined as necessary to build into the management platform: 1) order processing directly from medication wholesalers to physician's office; 2) tracking of step to determine time frame for each step in the ordering process; 3) virtual pharmacy inventory since all the medications at off-site location in the doctor's offices needed an automatic system to track and manage medication inventories for each medication at each doctor's office; and 4) re-allocation of medication whereby the ability to re-set the virtual inventory and re-assign un-opened medications for future patient usages is developed.

As part of the inventory management process, there was further the need to integrate the displaying, in real-time, inventory at each doctor's office, as well as the ability to track and compare each prescription processed by the ISSP for each doctor's office. Along those lines, there is a need to implement a process to track each medication prescription in the work flow.

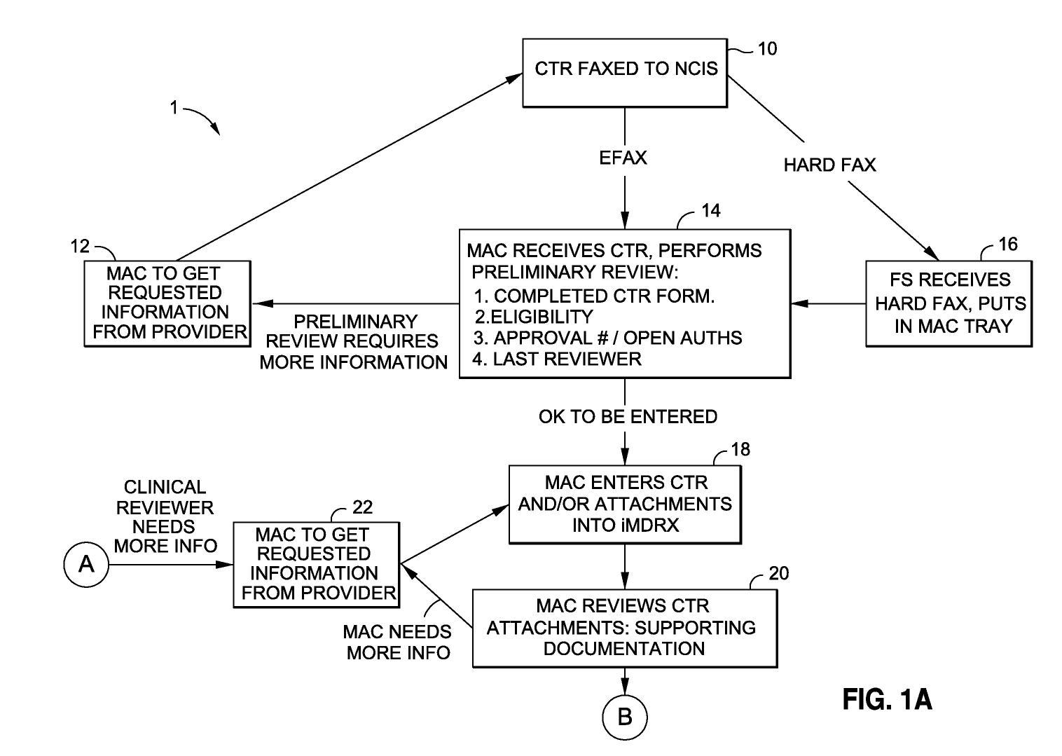

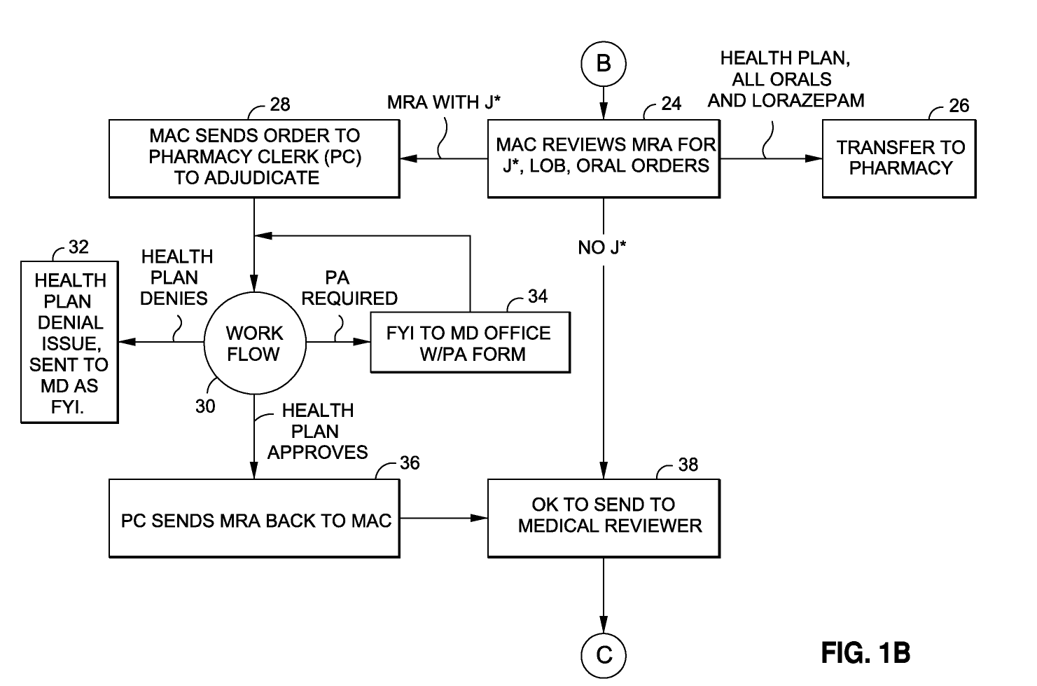

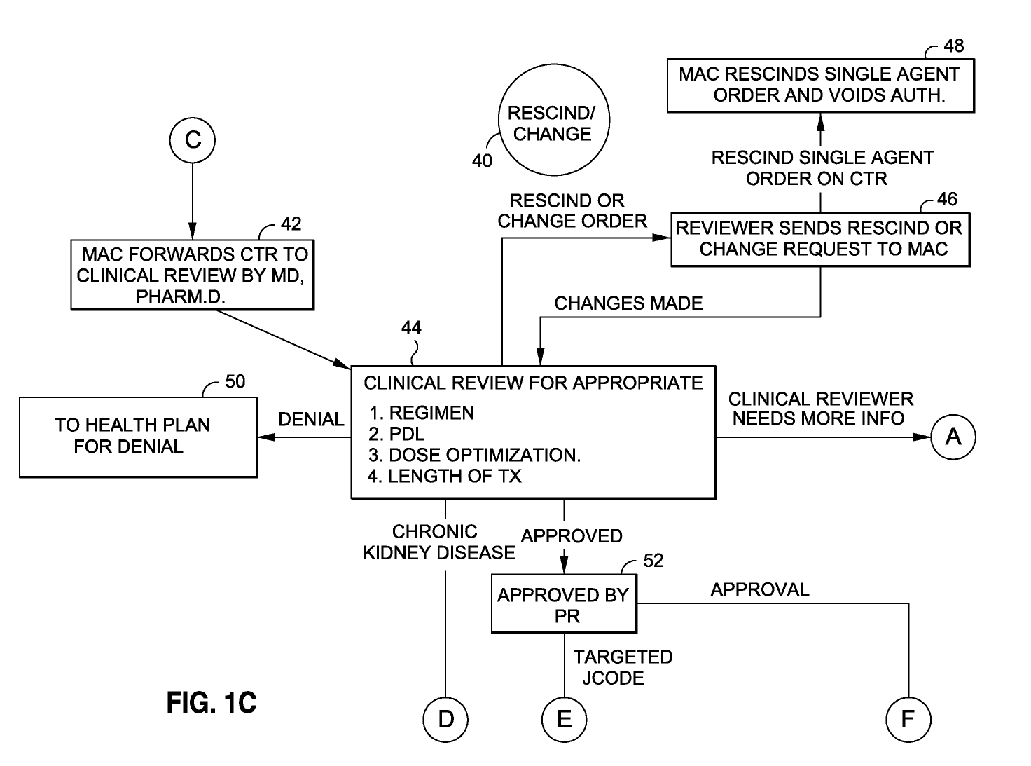

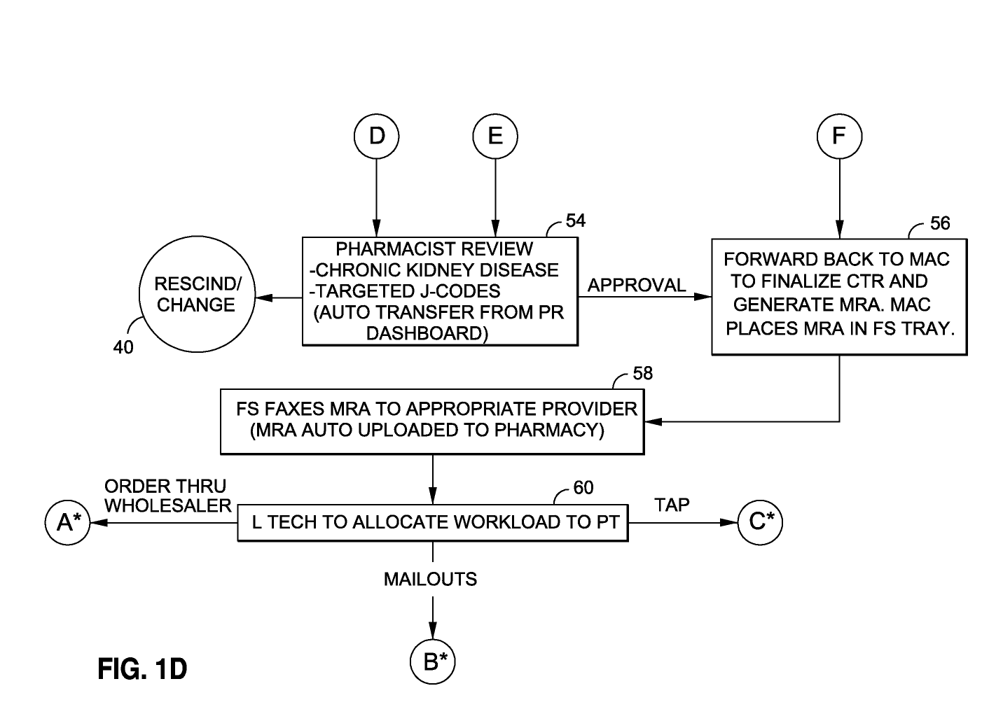

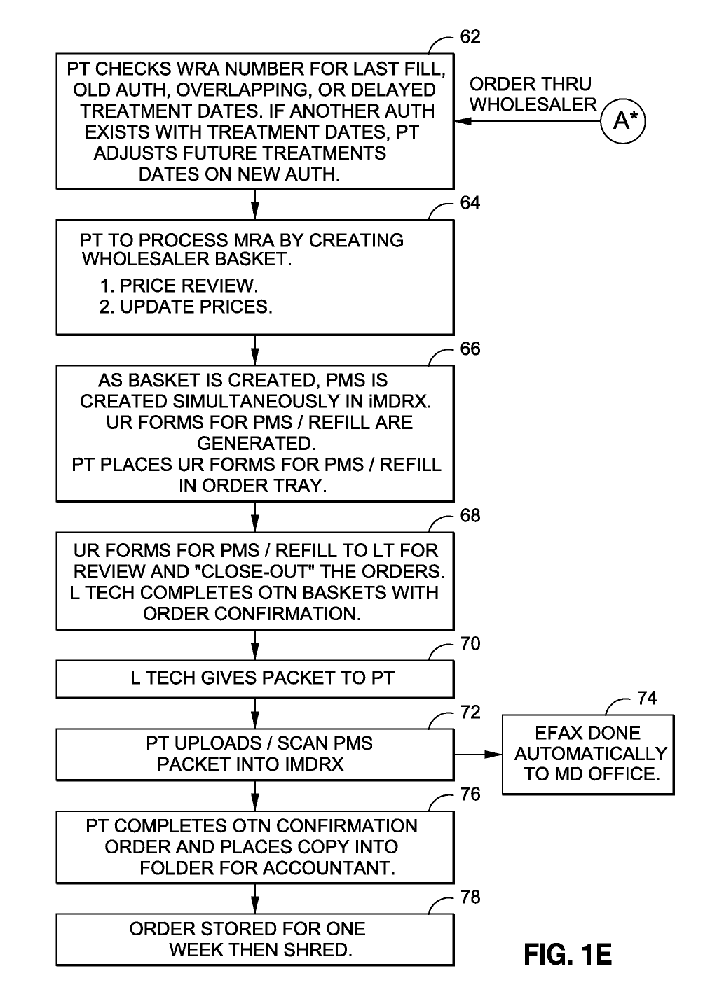

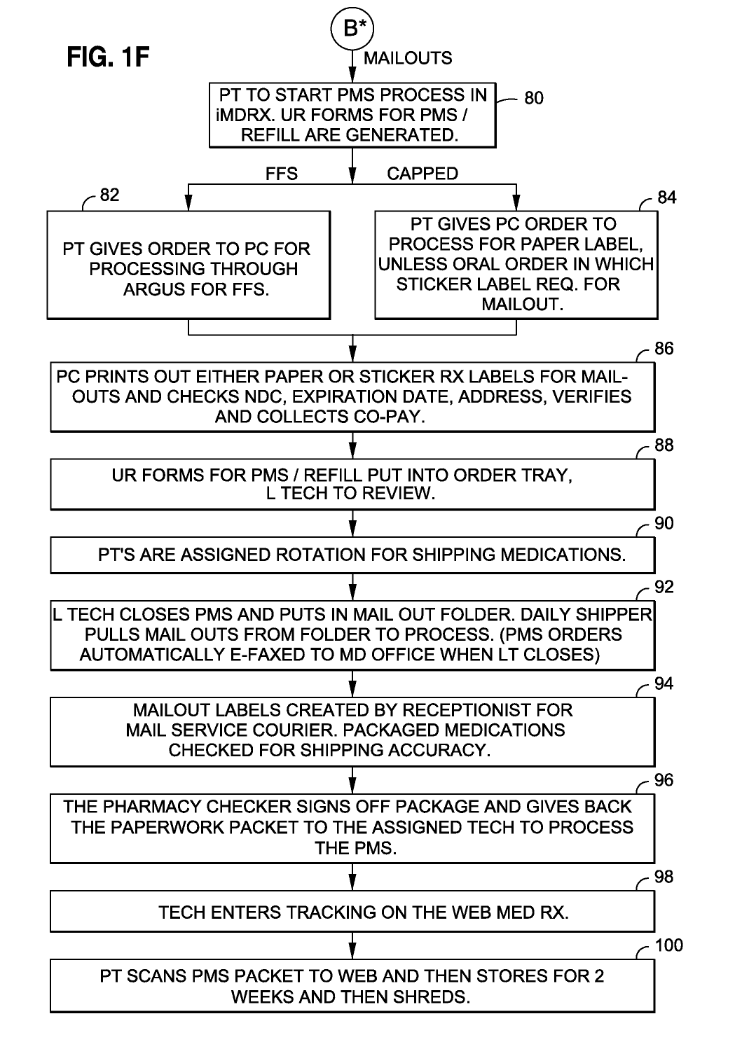

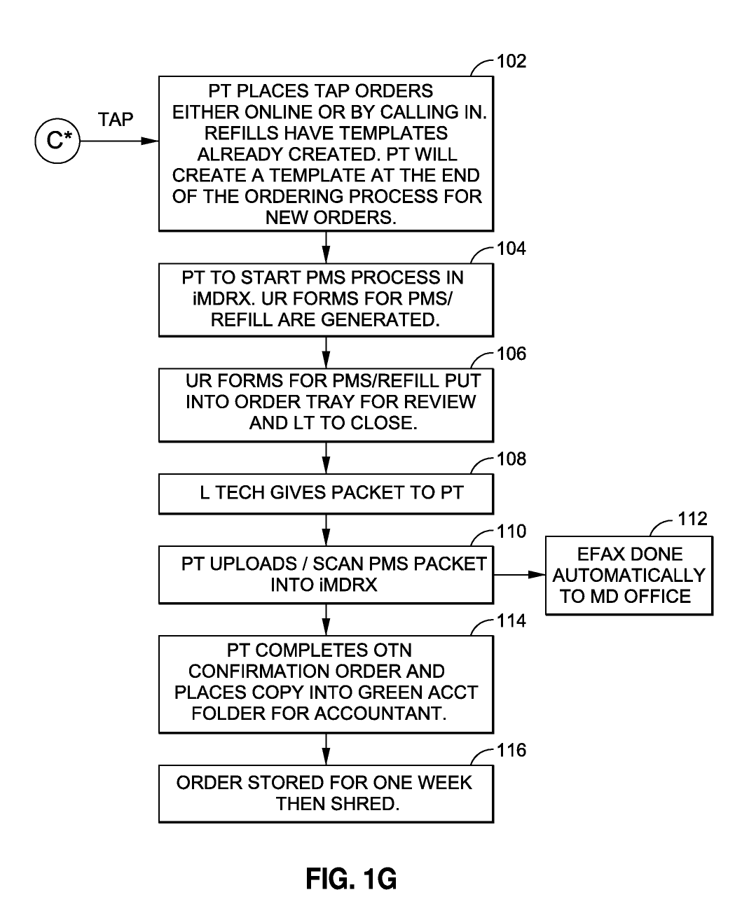

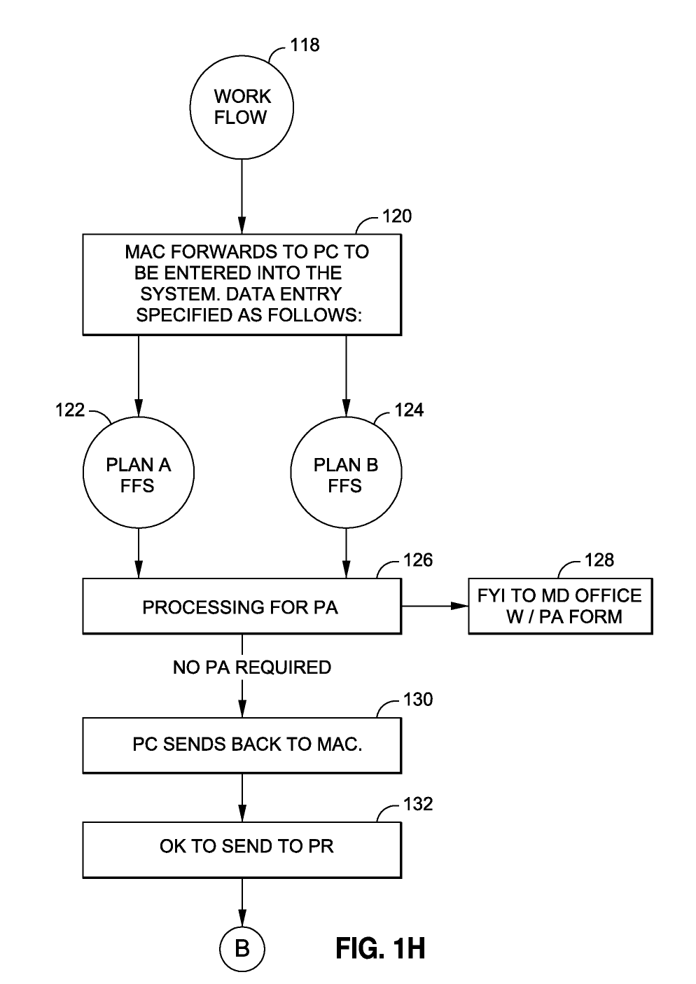

Bearing the foregoing in mind, and referring now to the drawing wherein the showing is for purposes of illustrating a preferred embodiment of the present invention only, and not for purposes of limiting the same, FIGS. 1A through 1H are a series of flow charts detailing the data input parameters and processing means and steps attendant to the implementation of the pharmaceutical inventory tracking system and method of the present invention.

To better understand the terminology used herein, there is provided a Glossary of Acronyms appearing in FIG. 1, as listed below.

Glossary of Acronyms appearing in FIG. 1:

AR—Accounts receivable

CTR—Chemotherapeutic Treatment Request

FFS—Fee for service

FS—Flow Sheet

iMDRX—Pharmaceutical inventory tracking system (subject invention)

J*—Meaning a FFS medication

LOB—Lines of Business

LT—Length of Treatment

LTech—Lead Technician (Pharmacy)

MAC—Medication Authorization Coordinator

MD—Medical Director

MRA—Medication Request Acknowledgement

NCIS—New Century Infusion Solutions (Applicant)

NDC—National Drug Code

OTN—Oncology Therapeutics Network (medication distributor)

PA—Prior Authorization

PC—Pharmacy Clerk

PDL—Preferred Drug List

PMS—Patient Medication Sheet

PR—Pharmacist Review

PT—Pharmacy Technician

TAP—Name of drug company

Tx—Treatment

UR—Utilization Review

Unless stated otherwise, such acronyms will be given the aforementioned definitions as will be readily understood and appreciated by those skilled in the art.

Generally speaking, in using the pharmacy virtual inventory management process of the present invention, a doctor's office initially requests a drug or prescription online through the use of a computer. Thereafter, an administrator evaluates the request. If the request is insufficient for some reason, the administrator requests more information from the doctor's office. If the required information is not received from the doctor's office or the administrative reviewer (e.g., an oncologist reviewer) does not approve the request, such request is sent to the patient's health plan for final review for approval or denial. If the information is sufficient, the request is forwarded to a Medical Director (requests from oncology are the exception to this because of the necessity for pharmacists to mix the drugs for each individual patient). The Medical Director can approve the request, pend it, or send it to health plan review (just like the administrator can if there is an insufficiency in the request). Approval means that the request is sent to a pharmacy and the order is filled. In this regard, pending means that further information is required and the drug requester is again contacted for more information. If the information received from the requester is sufficient, the request is approved or “finalized.” If the information requires off-label use of the drug or if the request is not approved, it goes to health plan review. Health plan review makes the ultimate decision regarding the request and has the discretion to approve or deny the same.

The advancements achieved by the pharmacy virtual inventory management process implemented by the system of the present invention provides virtual inventory management and tracking, which allows for the active monitoring of waste. The system also provides the ability to track ordering and pricing on multiple pricing platforms, and further provides the ability for peer-to-peer interaction and process improvements, such as medication treatment monitoring. The system further provides the ability to enable electronic medical records for specific disease state (e.g., oncology) treatments and monitoring via computer implementation. Further, the system provides the ability to track patients regardless of health plans. This particular feature is critical in that the system allows for the monitoring of medication usage and adverse events. Currently, if a patient goes from one health plan to another, all previous records are not available to the new health plan. In using the system of the present invention, patient tracking can be maintained, regardless of which health plan the patient joins.

To diagrammatically illustrate an exemplary implementation of the pharmaceutical inventory tracking system and method of the present invention, there is illustrated in FIGS. 1A-1H the various elements and steps by which the accuracy, adequacy, documentation, history, approval, administration and accuracy of a prescribed medication is documented and confirmed and/or denied and/or deferred as according to the novel and unique protocol established herein. As discussed above, although believed to be applicable for the medication associated with the treatment of any particular condition, whether acute or chronic in nature, it is believed that the systems and methods of the present invention are particularly well-suited in connection with oncology management and further taking into consideration, as appropriate, chronic kidney disease as is typically encountered when making medication therapy considerations in that regard.

When viewed in this context, the systems and methodology of the present invention 1 are initiated when a chemotherapeutic request (CTR) is communicated to the administrative authority implementing the present invention, referred herein to NCIS, at 10. Such request may be initiated from a medication authorization coordinator (MAC) at 12 from a healthcare provider. The CTR may further be communicated to the MAC via conventional facsimile via 16, or may be electronically transferred to the MAC electronically. Once received at 14, the MAC will review the CTR to ensure the same is submitted in accordance with appropriate protocol, as well as review the same to ensure that the same meets eligibility requirements, designate the CTR with an approval and certify any applicable authorizations, including the last reviewer to ensure the CTR was properly submitted. If necessary, the MAC can request more information back to 12. If acceptable, the MAC enters the CTR and any applicable attachments, documents, and the like into the pharmaceutical inventory tracking system or iMDRX at 18. Thereafter, the MAC will review the CTR attachments and supporting documentation at 20, which may prompt the MAC to request further information from the healthcare provider making the CTR at 22. To that end, input “A” will be provided to the MAC at 22, which in turn will be entered into the iMDRX at 18 as shown in FIG. 1A. Ultimately, once the MAC reviews the CTR and supporting documentation at 20, a further output “B” will be generated. An alternative methodology by which such assessment can be made to guide output “B” is shown in FIG. 1H discussed below.

Referring now to 1B, the output “B” from FIG. 1A regarding the CTR is reviewed by the MAC and thereafter recognized as a Medication Request Acknowledgment (MRA). The MRA is then reviewed by the MAC for certain specifics and appropriateness, including whether the MRA relates to a fee for service (FFS), designated J* whether the medication is orally administered and if the medication is included within a pre-approved health plan formulary, as well as the specific lines of business (LOB). With respect to the latter, it is contemplated that pharmaceutical inventory tracking systems and methods of the present invention will be implemented by pharmacy entities that assume fiscal responsibilities associated with a particular line of business, such as Medicare, Medicaid, or other commercial payors. In this regard, and as will be readily appreciated by those skilled in the art, the pharmacy entity will often take full fiscal responsibility for a particular LOB, such as Medicare, so that the pharmacy entity becomes the payor for the specific patients to which medications are provided. Accordingly, because of the specifics and protocol that are inherently unique to each line of business, it will be readily understood and appreciated by those skilled in the art that special considerations need to be taken when providing pharmacy benefits and filling prescriptions in accordance with a particular LOB, whether it be Medicare, Medicaid or a commercial LOB. Moreover, in the context of oncology, to the extent the MRA relates to a highly-regulated and widely utilized medication used as an adjunct to chemotherapy, such as lorazepam, which is frequently used as an adjunct antiemetic in chemotherapy or orally administered medications, the MRA is transferred to pharmacy at 26.

With respect to the fee for service (FFS) or J* designation associated with the MRA, to the extent the MRA is not associated with an FFS the same is approved to send to a medical reviewer at 38. On the other hand, to the extent the MRA is associated with an FFS, that is J*, the MAC sends the order at 28 to a Pharmacy Clerk (PC) to adjudicate or otherwise determine the appropriateness of the MRA and/or the applicable fee associated therewith. Along those lines, as is well-known, in order to contain healthcare costs it is typically considered appropriate to determine whether or not the FFS associated with the medication administration is appropriate. As a consequence of having the order sent to a Pharmacy Clerk (PC), the same is then ultimately forwarded to workflow 30 where the fate of the order is determined. With respect to the latter, the MRA with J* may be denied by a health plan at 32 for any of a variety of reasons, such as being cost-prohibitive, that lower cost alternatives are available, and the like. As a consequence of such denial 32, the medical director (MD) is provided notification.

Alternatively, the MRA with J* may require prior authorization (PA) and hence may be denied, kept in a pending state or otherwise not completed until such time as the PA requirements are met. In such instances, the MD is so advised at 34, and is requested to complete the necessary PA forms as may be necessary to ultimately approve the MRA with J* as ordered to the pharmacy clerk 28. In this regard, the order is then sent to workflow 30, and may again be denied at 32 or otherwise resent to the MD to complete whatever further formalities are required for the PA.

In a third alternative, the MRA with J*, to the extent approved by a health plan, will be returned to the MAC from the PC at 36. In this regard, in such circumstances the FFS associated with the MRA with J* will essentially have been approved with payment authorized, in which case such approval is sent to a medical reviewer at 38, thus culminating in output “C”, which continues from FIG. 1B to 1C.

With respect to FIG. 1C, the output “C” is assessed and may be optionally rescinded or changed via process 40 as graphically illustrated via the methodology depicted. In the context of a rescind/change order 40 as the same applies to a medicament applicable to chemotherapy, or as referenced earlier herein a CTR, the MAC will forward the CTR to an appropriate entity, whether the MD or a PharmD for clinical review at 42. The substantive clinical review at 44 is then made for the appropriateness of the CTR, which as illustrated includes: 1) the regimen of the CTR; 2) whether or not the medication is on a preferred drug list or formulary (PDL); 3) dose optimization or whatever further considerations may be made to optimize drug delivery and/or produce the desired therapeutic benefit; and 4) the length of treatment or TX.

If the CTR is deemed clinically inappropriate per 44, a denial is issued and forwarded to the applicable health plan at 50. Alternatively, to the extent further information is required by the clinical reviewer to determine the appropriateness of the CTR, such further input symbolized by “A”, indicating the clinical reviewer's need for more information is forwarded to the MAC at 22 shown in FIG. 1A and proceeds per the aforementioned methodology.

To the extent the CTR must be rescinded or changed based upon the clinical review at 44, the clinical reviewer sends the rescission or change request to the MAC at 46, who in turn can selectively rescind a single chemotherapeutic agent and void authorization at 48. Alternatively, to the extent the MAC changes the request by the reviewer, the MAC can make the appropriate changes and forward the same back for clinical review at 44.

Should the clinical review deems the CTR to be appropriate at 44, the approval is then forwarded and confirmed approved by Pharmacist Review (PR) at 52. The approval, to the extent the CTR is not associated with a fee for service, (FFS), approval is confirmed at output “F”.

On the other hand, to the extent the CTR is approved but affiliated with FFS, an appropriate billing code, such as a CPT code or referenced in FIG. 1C as a targeted code, is generated at output “E.” Similarly, in a context of chemotherapy medication management, to the extent clinical review at 44 involves the appropriateness of a CTR related to a patient with chronic kidney disease, a further consideration is involved characterized by output “D.”

Referring now to FIG. 1D, the aforementioned considerations involved in outputs “D” and “E”, respectively, are further assessed at 54. In this regard, a Pharmacist Review is made regarding the specific considerations associated with the CTR as viewed in connection with chronic kidney disease and the applicable FFS or J* codes that are applicable or targeted in connection with the medical management of a particular patient in view of the CTR. From such pharmacist review 54, the CTR may necessarily need to be rescinded or changed per 40, in which case the CTR reinitiates the rescind/change process outlined in connection with FIG. 1C.

Alternatively, to the extent the pharmacist review deems the considerations regarding targeted J* codes and chronic kidney disease not to warrant rescission or change, but otherwise be deemed approved, such approval is forwarded back to the MAC to finalize the CTR and generate a medication request acknowledgement (MRA) and the MAC advances such approval (characterized at 56 in FIG. 1D as placing the MRA in a flow sheet (FS) tray). As is illustrated, the approval of output “F” from FIG. 1C is likewise finalized in such a manner, with ultimately all finalized CTRs and generated MRA's therefrom in 56 being forwarded to the appropriate provider at 58, which may be accomplished via facsimile, electronic communications and other conventional communications means. The MRAs so communicated via 58 are directed to workload 60 where the length of treatment associated with the MRA is communicated to the appropriate entities responsible for supplying the appropriate medication that is the subject of the approved MRA, which is characterized in FIG. 1D as an output related to order through wholesaler, designated A*, mailouts, characterized by B*, or the applicable drug company responsible for manufacturing the medication(s), the specific name of the company being designated TAP, characterized by C*.

With respect to output A* regarding the order through a wholesaler, there is shown in FIG. 1E the methodology by which such order is processed. Initially, the pharmacy technician, where appropriate, will assess the MRA to determine when any previously approved prescriptions or medications were filled, any prior authorizations associated with previously dispensed medications, and especially to the extent there are any medications distributed that have been oversupplied or have overlapping quantities, whether previous orders were delayed, as well as other authorizations exists, and if so, the relevant treatment dates and the like.

From such assessment made at 62, the pharmacy technician will adjust all such prior history of medication previously authorized and supplied to a given patient and reconcile that with current and existing treatment, so that supply of medication is conserved and continuously administered per the appropriate regimen as discussed above. As will be appreciated by those skilled in the art, by making such assessment at 62, there is thus afforded the opportunity to prevent oversupplying a patient with medication and actually enhance the care provided to the patient by maintaining a continuity of medication not only deemed clinically appropriate given the aforementioned clinical review, but also by integrating the obligation to oversee the inventory of medication being supplied, the history by which the medication was supplied and at what dosage, and the length of time by which such medication has been prescribed. In this regard, it is contemplated that all such assessment and tracking information may be kept via electronic records or other computer-based implemented systems that will be operative to prevent waste and conserve medication. In this respect, by continuously updating the supply of medication being provided to a patient, as well as ensuring the same has been properly authorized and timely made available to the patient, substantial waste can be eliminated by means of the present invention whereby both orders of the medication, regardless of whether properly authorized or clinically appropriate, can be made available to a patient and often times producing subtherapeutic results at substantially higher costs.

Once the reconciliation is made at 62 with past medication, other authorizations, and the like, the pharmacy technician will process the MRA by determining the appropriate price for the medications associated with the MRA, and in particular whether or not the pricing has been updated. To that end, it is contemplated that the PT will process the MRA by creating a “wholesaler basket” concerning the specific medications that are associated with the MRA. To that end, as illustrated at 66, a patient medication sheet (PMS) is created as the “wholesaler basket” is created and is preferably done so simultaneously in iMDRX, typically via software implemented on a computer based system. Along these lines, Utilization Review (UR) forms for the PMS are generated, as well as any applicable refills and the like. The pharmacy tech forwards the UR forms for the PMS/refill, etc., for review and to “close out” the orders. The Lead Tech (LTech) completes OTN baskets with order confirmation. Thereafter, in the steps 70 and 72, the LTech gives the packet to the PT at 70 and the PT uploads or scans the PMS packet into the pharmaceutical inventory tracking system, as discussed above referenced herein as iMDRX. The packet may be e-faxed automatically to the MD at 74 or alternatively the PT completes and confirms the order to the medication distributor, the oncology therapeutics network (OTN), and the applicable documentation, whether electronic or paper, is forwarded to the appropriate folder for the accountant responsible to pay for the medications associated with the PMS at 76. To ensure privacy, as well as minimize paper handling and the like, a procedure 78 is implemented whereby the order documentation 76 is ultimately destroyed or eliminated after a prescribed time, such as one week as shown.

Referring now to FIG. 1F, the mailout output “B*” from FIG. 1D is processed according to the schematic flow chart as shown. Specifically, output B* is forwarded to a pharmacy technician to start the PMS generation process in the pharmaceutical inventory tracking system, iMDRX, with UR forms for PMS and applicable refills being generated at 80. To the extent the authorized medication set forth in the PMS relate to a fee for service or FFS, the PT gives an order to PC for processing for the applicable FFS. Alternatively, to the extent the payments associated with the medications that are the subject of the PMS are part of a “cap” benefit, the PT gives the PC order to process the applicable labeling attendant to the filling with prescriptions associated with the PMS at 84. Alternatively, to the extent applicable, if an oral order, a sticker label will be required for mailout. Along these lines, given the context of the mailout manner by which the medications that are the subject of the PMS are provided, it will be understood by those skilled in the art that the labeling associated with the PMS per 84 will be an integral part of the mailout process.

From either the FFS or “cap” manner by which the medications that are the subject of the PMS are handled, the PC will print out the applicable prescription labels, as well as confirms the NDC or National Drug Code associated with such medications, the expiration date of the applicable medications, the address of the patient's last destination to where the medications will be mailed out, and will further verify and collect any applicable co-pay associated with a particular health plan at 86.

At 88, any applicable UR forms for PMS/refills for the applicable medications will be put into order and reviewed and thereafter at 90, PT's are assigned rotation for shipping medications so as to increase the experience level and familiarity of the PT's with the aforementioned processes.

Once completed, the LTech closes the PMS and puts the same in a dedicated mailout folder with the daily shipper pulling out the mailout from the folder to process at 92 with mailout labels being created by a receptionist or other personnel for mail service carrier at 94. Moreover, the quality of the processes of the present invention is assured by checking the same for accuracy at 94. Thereafter the pharmacy checker, for purposes of accountability, will sign off on the package and give the applicable paperwork packet to the assigned Pharmacy Technician to process the applicable PMS at 96. The tech then enters the tracking of the specific package via a web based system, referenced herein as WebMedRX. The PT then scans the PMS packet to the web based system and, according to a preferred protocol, stores the same for approximately two weeks and then shreds or otherwise destroys to thus prevent the unwanted accumulation of paperwork and/or digital information. As will be readily appreciated by those skilled in the art, alternative methods for generating, shipping, storing and handling of data may be accomplished by any of a variety of similar ways known to those skilled in the art.

Referring now to FIG. 1G, the output “C*” from FIG. 1D related to TAP is assessed. As illustrated, at 102 the PT places the TAP orders either by submitting the same online or by calling the same in. Insofar as the TAP will involve a transaction dealing directly with a particular drug company such as Astra-Zeneca, that is also a distributor, it will be readily appreciated that refills for any particular medications have templates already created, however, to the extent the order applies to a new order, it will be understood that the PT will have to create a template at the end of the initial ordering process.

At 104 and 106, the PT will start the PMS process in iMDRX and the UR forms for PMS/refills are generated at 104 and the UR forms for PMS/refill will be forwarded for review and LTech to close. Thereafter at 108, the LT will give the packet of applicable information to the PT who then at 110 will upload and scan in the PMS packet into iMDRX. To the extent this is done via electronic transmission, such as EFAX at 112, the same will automatically be transferred to the MD office.

Alternatively, if other than by electronic transmission, such as EFAX at 112, the PT will complete the order applicable for the applicable medicines, via completion of the OTN confirmation and will forward the order information to accounting to thus seek reimbursement. The information associated with the particular PMS per output C* is then stored for a prescribed time and then destroyed, such as one week, at 116.

Referring now to FIG. 1H, there is shown the consecutive steps by which information from a workflow 118, similar to 30 in FIG. 1B, regarding the approval and authorization to pay for a given medication is shown, which is attendant to certain principles of the present invention. As illustrated at 120, the MAC will forward to the pharmacy clerk (PC) information regarding a MRA to be entered into a particular system that, depending upon the particular type of health plan, will proceed through the appropriate administrative channels for a particular health plan as the same relates to a specific FFS associated with a specific MRA. In this regard, and as will be readily appreciated by those skilled in the art, the methodology by which step 120 is performed will essentially be computer-based and implemented via software applications operative to receive input data and used to adjudicate pharmacy claims, including the RX30 Pharmacy System distributed by Transaction Data Systems of Ocoee, Fla. Other commercial software readily available and intended for such purpose, namely, to assess pharmacy claims through a specific health plan pharmacy system, also known as a pharmacy benefit manager (PBM), may also be utilized.

As illustrated, to the extent the applicable medication is associated with an FFS administered through health Plan A at 122, the same will be forwarded through such health plan administrative channels for approval, documentation and the like. Alternatively, to the extent the MRA associated with the FFS associated a health Plan B, at 124, the same will pass though such channels. As will be appreciated by those skilled in the art, Plan A and Plan B are merely exemplary of specific types of health plans that may require prior notification and approval insofar as the same relates to an FFS associated with a particular MRA.

In either case, the MRA associated with an FFS, or J* as previously referenced with respect to FIG. 1B, the same is processed for prior authorization (PA) at 126 and may be forwarded to the medical director with applicable documentation of PA form to secure the necessary approval. Alternatively, to the extent no prior authorization (PA) is required, the MRA will be sent by the pharmacy clerk (PC) to the MAC at 130 who will ultimately OK the MRA to be sent to the PR at 132. In this respect, elements 130 and 132 closely mirror those elements 36, 38 referenced above with respect to FIG. 1B. In this regard, the steps set forth in FIG. 1H merely provide an alternative means by which alternative health care plans, such as Plan A and Plan B at 122, 124 may further review and confirm the appropriateness of a particular MRA similar to that as described above for FIG. 1B.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed:

1. A pharmaceutical inventory tracking method implemented in response to a request to provide medications to a patient, the method comprising the steps:
a. receiving and forwarding a medication request to a medication authorization coordinator for review to determine completeness and accuracy of said request wherein said request being approved by said medication authorization coordinator is designated as a medication request acknowledgment;
b. designating said medication request acknowledgment in step a) as either being associated with a fee for service or not associated with a fee for service;
c. certifying said medication request acknowledgment associated with a fee for service in step b) as either denied, approved or requiring prior authorization;
d. forwarding said approved medication request acknowledgment associated with a fee for service in step c) and said medication request acknowledgment not associated with a fee for service in step c) for review for clinical appropriateness wherein said appropriateness is determined by at least one factor selected from the group consisting of medication regimen, dose optimization and length of treatment with said medication, wherein said medication request acknowledgments being deemed clinically appropriate are designated as approved;
e. forwarding and tracking said approved request in step d) to said medication authorization coordinator and from said medication authorization coordinator to a medication supplier means.

2. The method of claim 1 wherein said medication supplier means comprises a medication supplier wholesaler operative to receive and fill an order generated in step e).

3. The method of claim 1 wherein said medication supplier means comprises a mailout order by which medications may be supplied via mail delivery.

4. The method of claim 1 wherein the medication supplier means comprises a specified pharmaceutical company.

5. The method of claim 1 wherein said medication request of step a) is a chemotherapeutic treatment request.

6. The method of claim 5 wherein prior to step e), the method further comprises the steps:
a. determining whether the patient for which the chemotherapeutic treatment request is made is afflicted with chronic kidney disease; and
b. making a secondary review for clinical appropriateness of the chemotherapeutic treatment request to the extent said patient is afflicted with chronic kidney disease.

7. The method of claim 5 wherein said chemotherapy treatment request of step a) is associated with a fee for service and wherein prior to step e), the method further comprises the step:
a. making a secondary review for clinical appropriateness of the chemotherapeutic treatment request associated with said fee for service.

8. The method of claim 2 wherein said method further comprises the steps:
a. confirming said approved medication request acknowledgment for ordering through said wholesaler, and comparing said approved medication request acknowledgment with any other prior-approved medications previously supplied to said patient;
b. generating a patient medication sheet regarding said medications approved to be supplied to said patient and ordering said medications from said patient medications sheet through said wholesaler; and
c. documenting that said order is fulfilled.

9. The method of claim 3 wherein said method further comprises the steps:
a. generating a patient medication sheet identifying which medications are approved to be supplied to said patient and categorizing said medications to be supplied as either associated with a fee for service or not associated with a fee for service;
b. generating the mail order request and thereafter tracking said order; and
c. documenting said order.

10. The method of claim 4 wherein said method further comprises the steps:
a. contacting said specified pharmaceutical company and ordering said approved medications pursuant to said approved medication request acknowledgment; and
b. transmitting said order to said specified pharmaceutical company and documenting said order.
